(19) United States
(12) Patent Application Publication
(10) Pub. No.: US 2012/0240180 A1
(43) Pub. Date: Sep. 20, 2012

(54) SET-TOP BOX, EARPHONE, AND MULTIMEDIA PLAYING METHOD

(75) Inventor: HUNG-CHANG LIN, Tu-Cheng (TW)

(73) Assignee: HON HAI PRECISION INDUSTRY CO., LTD., Tu-Cheng (TW)

(21) Appl. No.: 13/116,024

(22) Filed: May 26, 2011

(30) Foreign Application Priority Data
Mar. 16, 2011 (CN) 201110063203.1

(51) Int. Cl. H04N 7/16

(52) U.S. Cl. 725/153

(57) ABSTRACT

A set-top box receives a multimedia program from a headend server. The multimedia program includes a video content and a plurality of corresponding audio contents each corresponding to a sign. The set-top box transmits the video content and one of the audio contents to a multimedia playing device. The set-top box connects to each earphone, transmits the signs corresponding to the audio contents to each earphone, and receives one of the signs and the corresponding unique identifier from each earphone. The set-top box transmits one of the audio contents corresponding to the received sign to one of the earphones according to the received corresponding unique identifier.

### BACKGROUND

1. Technical Field

Embodiments of the present disclosure relate to multimedia playing technology, and more particularly to a set-top box, an earphone, and a multimedia playing method.

2. Description of Related Art

A home entertainment system often includes a set-top box and a multimedia playing device, namely a television. The set-top box receives and decodes multimedia programs from a headend server of a content provider and the multimedia playing device plays the decoded multimedia programs. Most of the multimedia programs, such as a movie, provide more than one language for different users, such as Mandarin Chinese, Cantonese, and English.

In the home entertainment system, a user can use a controller to select one language from the multiple languages provided by the multimedia programs. However, in a family, different family members may like different languages. For example, as for an American movie, an elder family member may like Mandarin Chinese or Cantonese, while a younger one may like the original language, namely English. This conflict makes family members cannot watch a multimedia program together. There remains a heretofore unaddressed need to overcome the limitations described.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of environment of a set-top box and a plurality of earphones of one embodiment of the present disclosure;

FIG. 2 is a schematic diagram of functional modules of a set-top box of one embodiment of the present disclosure;

FIG. 3 is a schematic diagram of functional modules of an earphone of one embodiment of the present disclosure; and

FIG. 4 is a flowchart of a multimedia playing method of one embodiment of the present disclosure.

### DETAILED DESCRIPTION

All of the processes described may be embodied in, and fully automated over, software code modules executed by one or more general purpose computers or processors. The code modules may be stored in any type of computer-readable medium or other storage device. Some or all of the methods may alternatively be embodied in specialized computer hardware or communication apparatus.

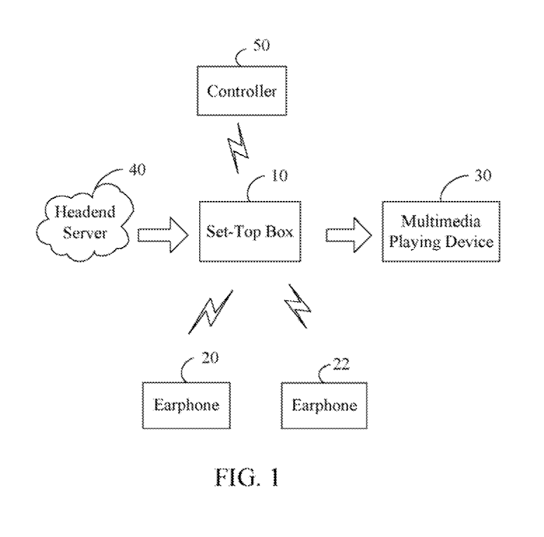

FIG. 1 is a schematic diagram of application environment of a set-top box 10 and a plurality of earphones 20, 22 of one embodiment of the present disclosure. In the embodiment, the set-top box 10, the plurality of earphones 20, 22, and a multimedia playing device 30 form an entertainment system. It should be noted that only two earphones 20 and 22 are shown, but more than two earphones can be used in the entertainment system.

The set-top box 10 communicates with a headend server 40 and receives a multimedia program from the headend server 40. The set-top box 10 transmits the multimedia program to the multimedia playing device 30. The multimedia playing device 30 plays the multimedia program. In one embodiment, the headend server 40 is located in a center office and provided by content providers. The multimedia playing device 30 may be a television in a home.

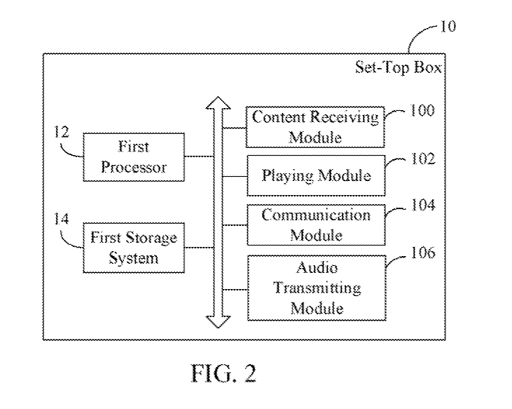

FIG. 2 is a schematic diagram of functional modules of the set-top box 10 of one embodiment of the present disclosure. In one embodiment, the set-top box 10 includes a first processor 12, a first storage system 14, a content receiving module 100, a playing module 102, a communicating module 104, and an audio transmitting module 106.

The above modules 100-106 may comprise one or more software programs in the form of computerized codes that are stored in the first storage system 14. The computerized codes include instructions that are executed by the first processor 12 to provide functions for those modules 100-106. In one embodiment, the first storage system 14 includes a synchronous dynamic random access memory (SDRAM), a hard disk drive (HDD), and other kinds of hardware in which data can be stored.

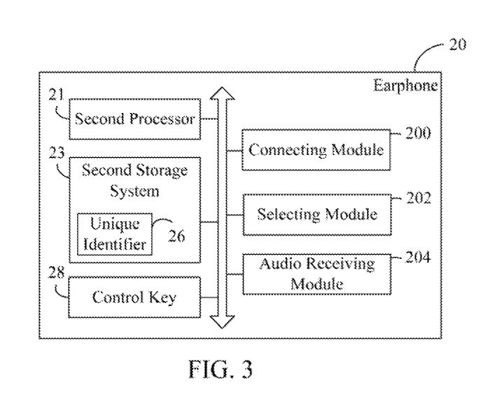

FIG. 3 is a schematic diagram of functional modules of the earphones 20, 22 of one embodiment of the present disclosure. The earphone 22 has a same configuration and structure as that of the earphone 20. Thus, hereinafter the earphone 20 is taken as an example. In one embodiment, the earphone 20 includes a second processor 21, a second storage system 23, a connecting module 200, a selecting module 202, and an audio receiving module 204.

The above modules 200-204 may comprise one or more software programs in the form of computerized codes that are stored in the second storage system 23. The computerized codes include instructions that are executed by the second processor 21 to provide functions for those modules 200-204. In one embodiment, the second storage system 23 includes a synchronous dynamic random access memory (SDRAM), a flash memory, and other kinds of hardware in which data can be stored.

In one embodiment, the earphone 20 has a unique identifier 26 stored in the second storage system 23 of the earphone 20. A control key 28 is configured in the earphone 20. Once a user of the earphone 20 presses the control key 28, the control key 28 generates a control signal.

A user controls the set-top box 10 by a controller 50 to select a multimedia program that the user requires. Then, the content receiving module 100 of the set-top box 10 receives the selected multimedia program from the headend server 40. In the embodiment, the multimedia program comprises a video content and a plurality of corresponding audio contents. Each of the audio contents corresponds to a language, such as Mandarin Chinese, Cantonese, English, or any other language.

Each of the audio contents corresponds to a sign. In one embodiment, the sign is a parameter to uniquely identify each of the audio contents and is defined by a video playing protocol of the set-top box 10. For example, according to MPEG2 protocol, the sign is a packet identifier of each of the audio contents.

The playing module 102 of the set-top box 10 obtains the video content, the plurality of corresponding audio contents with corresponding signs. The playing module 102 subsequently transmits the video content and one of the audio contents to the multimedia playing device 30. Then, the multimedia playing device 30 plays the video content and one of the audio contents received from the playing module 102 of the set-top box 10. If the language played by the multimedia playing device 30 is not what the user requires, the user controls the set-top box 10 to select the language the user requires by use of the controller 50.

The playing module 102 of the set-top box 10 transmit the audio content relating to the language the user requires to the multimedia playing device 30. Then, the multimedia playing device 30 plays the multimedia program with the language the user requires. Subsequently, other users who require other languages use the plurality of earphones 20, 22.

For example, a user “A” uses the controller 50 to select the Mandarin Chinese, and then the multimedia playing device 30 plays with language of the Mandarin Chinese. Meanwhile, a user “B” who is used to listening Cantonese can use the earphone 20, and a user “C” who is used to listening English can use the earphone 22. The user “A”, the user “B”, and the user “C” watch the same video contents of the multimedia program played by the multimedia playing device 30 together, and listen to different languages of the audio contents corresponding to the multimedia program respectively.

When the users “B” and “C” respectively use the earphones 20, 22, the connecting module 200 of the earphone 20 or 22 connects to the set-top box 10 to establish communication with the set-top box 10. Then, the communicating module 104 of the set-top box 10 transmits the signs corresponding to the audio contents to the earphones 20, 22 after connecting to the earphones 20, 22. Then, the selecting module 202 of the earphone 20 or 22 receives the signs corresponding to the audio contents from the set-top box 10, and then selects one of the signs and transmits the selected sign and the corresponding unique identifier 26 to the set-top box 10.

Subsequently, the communicating module 104 of the set-top box 10 receives the selected sign and the corresponding unique identifier 26 from the earphones 20 or 22. The audio transmitting module 106 of the set-top box 10 transmits one of the audio contents corresponding to the selected sign to the earphones 20, 22 according to the received corresponding unique identifier 26.

The audio receiving module 204 of the earphones 20 or 22 receives one of the audio contents corresponding to the selected sign from the set-top box 10 according to the corresponding unique identifier 26. As such, the user of the earphone 20 or 22 can listen to the audio content to determine if the language of the audio content is that required.

If the user of the earphone 20 or 22 has not listened to the required language, the user presses the control key 28 of the earphone 20 or 22 and the control key 28 generates the control signal. Then, the selecting module 202 of the earphone 20 or 22 detects the control signal, and selects a next one of the signs and transmits the next selected sign and the corresponding unique identifier 26 to the set-top box 10 to switch another one of the audio contents. The user of the earphone 20 or 22 presses the control key 28 until hearing the required language.

For example, the playing module 102 of the set-top box 10 obtains one set of video content and corresponding three sets of audio contents. The three sets of audio contents are the Mandarin Chinese, Cantonese and English, respectively corresponding to three signs “1”, “2”, and “3”. The communicating module 104 of the set-top box 10 transmits the three signs “1”, “2”, and “3” to the connected earphones 20, 22. The selecting modules 202 of the earphones 20, 22 both transmit sign “1” to the set-top box 10 upon the control keys 28 being pressed.

Subsequently, the audio transmitting module 106 of the set-top box 10 transmits the audio content corresponding to sign “1” to the earphones 20, 22. The earphones 20, 22 both play the received audio content with language of the Mandarin Chinese. However, for example, the user of the earphone 20 is used to listening Cantonese, and the user of the earphone 22 is used to listening to English.

Thus, the users of the earphones 20, 22 continue to press the control key 28 to transmit sign “2” to the set-top box 10 to switch to the audio content of Cantonese. The user of the earphone 22 continues to press the control key 28 one more time to transmit sign “3” to the set-top box 10 to switch to the audio content of English. Then, the users of the earphones 20, 22 both can respectively use the earphones 20, 22 to listen to their required languages, namely, Cantonese and English.

When the user actively stops using the earphone 20 or 22, or the earphone 20 or 22 disconnects from the set-top box 10 because of, for example, bad communication conditions, the audio transmitting module 106 of the set-top box 10 detects that the earphone 20 or 22 disconnects from the set-top box 10, and stops transmitting the audio content to the disconnected earphone 20 or 22.

When the user of the controller 50 controls the set-top box 10 to switch to another multimedia program using the controller 50, the communication module 104 of the set-top box 10 determines if the earphone 20 or 22 is still connected to the set-top box 10. Then, the communication module 104 of the set-top box 10 transmits the signs corresponding to audio contents of another multimedia program to the connected earphones 20, 22. Then, the connected earphone 20 or 22 selects the sign corresponding to another multimedia program and transmits to the set-top box 10.

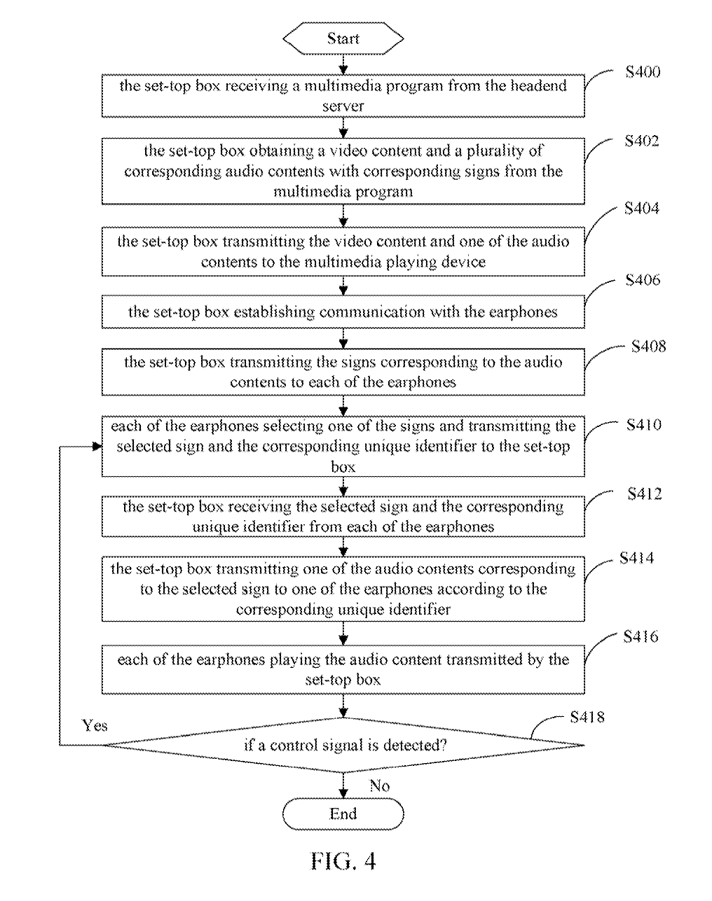

FIG. 4 is a flowchart of a multimedia playing method of one embodiment of the present disclosure. The flowchart is executed by the modules of the entertainment system of FIG. 1. Depending on the embodiment, additional blocks may be added, others deleted, and the ordering of blocks may be changed while remaining well within the scope of the disclosure.

In block S400, the content receiving module 100 of the set-top box 10 receives the selected multimedia program from the headend server 40. In the embodiment, the multimedia program comprises a video content and a plurality of corresponding audio contents. Here, each of the audio contents corresponds to a language, such as Mandarin Chinese, Cantonese, English, or any other language. Each of the audio contents corresponds to a sign.

In block S402, the playing module 102 of the set-top box 10 obtains the video content, and the plurality of corresponding audio contents with the corresponding signs from the multimedia program. In block S404, the playing module 102 of the set-top box 10 subsequently transmits the video content and one of the audio contents to the multimedia playing device 30.

In block S406, the connecting module 200 of the earphone 20 or 22 connects to the set-top box 10 to establish communication with the set-top box 10. In block S408, the communicating module 104 of the set-top box 10 transmits the signs corresponding to the audio contents to the earphones 20, 22 after connecting to the earphones 20, 22.

After receiving the signs corresponding to the audio contents from the set-top box 10, in block S410, the selecting module 202 of the earphone 20 or 22 selects one of the signs and transmits the selected sign and the corresponding unique identifier 26 to the set-top box 10. In block S4102, the communicating module 104 of the set-top box 10 receives the selected sign and the corresponding unique identifier 26 from the earphones 20, 22. In block S414, the audio transmitting module 106 of the set-top box 10 transmits one of the audio contents corresponding to the selected sign to the earphones 20, 22 according to the received corresponding unique identifier 26.

In block S416, the audio receiving module 204 of the earphone 20 or 22 receives one of the audio contents corresponding to the selected sign from the set-top box 10 according to the corresponding unique identifier 26. In block S418, the selecting module 202 of the earphone 20 or 22 determines if a control signal generated by the control key 28 of the earphone 20 or 22 is detected. If the control signal is detected, then, in block S410, the selecting module 202 of the earphone 20 or 22 selects a next one of the signs and transmits the selected next sign and the corresponding unique identifier 26 to the set-top box 10 until the user hears the earphone 20 or 22 playing the required language.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A set-top box in communication with a headend server, a multimedia playing device, and a plurality of earphones each comprising a unique identifier, the set-top box comprising:
a processor; and
a storage system storing one or more software programs in the form of computerized codes operable to be executed by the processor, the one or more software programs comprising:
a content receiving module that receives a multimedia program from the headend server, the multimedia program comprising video content and a plurality of corresponding audio contents, each of the audio contents corresponding to a sign;
a playing module that transmits the video content and one of the audio contents of the multimedia program to the multimedia playing device;
a communicating module that connects to each of the earphones, transmits the signs corresponding to the audio contents to each of the earphones, and receives one of the signs and the corresponding unique identifier from each of the earphones; and
an audio transmitting module that transmits one of the audio contents corresponding to the received sign to one of the earphones according to the received corresponding unique identifier.

2. The set-top box as claimed in claim 1, wherein the audio transmitting module determines if one of the earphones disconnects from the set-top box and stops transmitting the audio content to the disconnected earphone upon the condition that the disconnected earphone is detected.

3. The set-top box as claimed in claim 1, wherein the communication module determines if each of the earphones is still connected to the set-top box when the content receiving module receives another multimedia program, and transmits the signs corresponding to the audio contents of the another multimedia program to the connected earphones.

4. An earphone in communication with a set-top box and comprising a unique identifier, the set-top box receiving a multimedia program from a headend server, the multimedia program comprising a video content and a plurality of corresponding audio contents, each of the audio contents corresponding to a sign, the earphone comprising:
a control key that generates a control signal;
a processor; and
a storage system storing one or more software programs in the form of computerized codes operable to be executed by the processor, the one or more software programs comprising:
a connecting module that establishes communication with the set-top box;
a selecting module that receives the signs corresponding to the audio contents from the set-top box, selects one of the signs, and transmits the selected sign and the unique identifier to the set-top box; and
an audio receiving module that receives one of the audio contents corresponding to the selected sign from the set-top box according to the corresponding unique identifier;
wherein the selecting module selects next one of the signs and transmits the selected next sign and the unique identifier to the set-top box to switch another one of the audio contents when the control signal is detected.

5. A multimedia playing method for an entertainment system comprising a set-top box, a multimedia playing device, and a plurality of earphones each comprising a unique identifier, the set-top box communicating with a headend server, the method comprising:
the set-top box receiving a multimedia program from the headend server, the multimedia program comprising a video content and a plurality of corresponding audio contents, each of the audio contents corresponding to a sign;
the set-top box transmitting the video content and one of the audio contents of the multimedia programs to the multimedia playing device;
the set-top box establishing communication with the plurality of the earphones;
the set-top box transmitting the signs corresponding to the audio contents to each of the earphones;
each of the earphones selecting one of the signs and transmitting the selected sign and the corresponding unique identifier to the set-top box;
the set-top box transmitting one of the audio contents corresponding to the selected sign to one of the earphones according to the corresponding unique identifier;
each of the earphones playing the audio content transmitted by the set-top box and determining if a control signal is detected; and
each of the earphones selecting next one of the signs and transmitting the selected next sign and the corresponding unique identifier to the set-top box to switch another one of the audio contents if the control signal is detected.

6. The method as claimed in claim 5, further comprising:
the set-top box determining if one of the earphones is disconnected from the set-top box; and
the set-top box stopping transmitting the audio content to the disconnected earphone if the disconnected earphone is detected.

7. The method as claimed in claim 5, further comprising:
the set-top box receiving another multimedia program;
the set-top box determining if each of the earphones is still connected; and
the set-top box transmitting another signs corresponding to another audio contents of the another multimedia program to the connected earphones.
